(19) United States
(12) Patent Application Publication
(10) Pub. No.: US 2008/0168770 A1
(43) Pub. Date: Jul. 17, 2008

(54) Cooling system for an engine having high pressure EGR and machine using same

(76) Inventors: Mahesh Mokire, Peoria, IL (US); Mustafa Al-Shawaf, Washington, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/653,754

(22) Filed: Jan. 16, 2007

(51) Int. Cl. F02B 29/04; F02B 33/44; F01N 3/021

(52) U.S. Cl. 60/599; 60/605.2; 60/274

(57) ABSTRACT

A machine includes an internal combustion engine having an intake manifold and an exhaust manifold. An intake air conduit extends from a compressor of a turbocharger to the intake manifold and a charge air cooler is disposed along the intake air conduit. An exhaust conduit extends from the exhaust manifold to a turbine of the turbocharger. The machine also includes a recirculation conduit. An inlet of the recirculation conduit connects to the exhaust conduit and an outlet of the recirculation conduit connects to the intake air conduit upstream of the charge air cooler. The machine also includes a radiator fluidly connected to the internal combustion engine. The charge air cooler is positioned for receiving ambient air moved through the radiator by a radiator fan.

### TECHNICAL FIELD

The present disclosure relates generally to an internal combustion engine having high pressure exhaust gas recirculation (EGR), and more particularly to the relative positioning of a charge air cooler and radiator of the engine.

### BACKGROUND

Internal combustion engines, such as diesel engines, often have one or more turbochargers to compress intake air going into the engine. This increases the amount of air going into the engine, thereby increasing the performance and efficiency of the engine. An effect of the air compression by the turbocharger includes an increase in the temperature of the air. Since high temperatures of combustion lead to an increase in nitrous oxide (NOₓ) production and since the government regulates the amount of NOₓ that may be produced, it is often preferable to cool the compressed air before it enters the engine.

Known methods of cooling the intake air include the use of a charge air cooler, such as, for example, an air to air aftercooler, which is typically mounted at a location for receiving fresh ambient air. Compressed intake air is routed through the tubes of the air to air aftercooler to the engine. Specifically, fresh ambient air flowing over the air to air aftercooler tubes cools the compressed intake air as it flows through the aftercooler. As a result, the temperature of combustion, and consequently NOₓ formation, are reduced.

Another method of controlling the production of undesirable gases, particularly NOₓ, in internal combustion engines includes the use of an exhaust gas recirculation (EGR) system. These systems recirculate exhaust gases into the intake air supply of the engine. The exhaust gases, which have already combusted and therefore do not burn again, displace some of the intake air charge, thereby slowing and cooling the combustion process.

One EGR system includes reintroducing an exhaust gas into a charged intake air supply upstream of an air to air aftercooler. In this system, however, the air inlet temperature to the air to air aftercooler is increased by the heat of the exhaust gas. In typical configurations, the air to air aftercooler is placed for receiving fresh ambient air. If this location is in the path of ambient air to the radiator, the increase in the air to air aftercooler heat load decreases radiator performance. While it may be desirable to increase the size or change the location of the radiator to compensate for the poor performance, cost and space limitations may preclude such solutions.

In one comparable system, described in U.S. Pat. No. 6,408,831, the air to air aftercooler is located above the radiator. This reference describes a system for restricting the flow of ambient air for use by an air to air aftercooler to maintain a desired inlet manifold temperature. The system described utilizes low pressure (and cooler) EGR drawn from the flow downstream of a turbine of the turbocharger. Because of the lower heat transfer demands on the air to air aftercooler, this reference suggests that the air to air aftercooler could be located virtually anywhere. However, the reference does not contemplate a need for a specific placement within the machine where there is an increased heat load on the air to air aftercooler.

The present disclosure is directed to one or more of the problems set forth above.

### SUMMARY OF THE INVENTION

In one aspect, a machine includes an internal combustion engine having an intake manifold and an exhaust manifold. An intake air conduit extends from a compressor of a turbocharger to the intake manifold and a charge air cooler is disposed along the intake air conduit. An exhaust conduit extends from the exhaust manifold to a turbine of the turbocharger. The machine also includes a recirculation conduit. An inlet of the recirculation conduit connects to the exhaust conduit and an outlet of the recirculation conduit connects to the intake air conduit upstream of the charge air cooler. The machine also includes a radiator fluidly connected to the internal combustion engine. The charge air cooler is positioned for receiving ambient air moved through the radiator by a radiator fan.

In another aspect, a method of operating an engine includes a step of cooling an engine coolant within a radiator using ambient air drawn through the radiator by a fan. The method also includes a step of channeling exhaust into a recirculation conduit upstream of a turbine of a turbocharger. The method further includes a step of combining the exhaust from the recirculation conduit with intake air, wherein the intake air includes air charged by a compressor of the turbocharger. The method further includes a step of cooling the combined exhaust and intake air with a charge air cooler using the ambient air that has passed through the radiator.

### BRIEF DESCRIPTION OF THE DRAWINGS

FIG. 1 is a side diagrammatic view of a machine having a cooling system according to the present disclosure; and

FIG. 2 is a schematic of an internal combustion engine incorporating a high pressure EGR technology according to the present disclosure.

### DETAILED DESCRIPTION

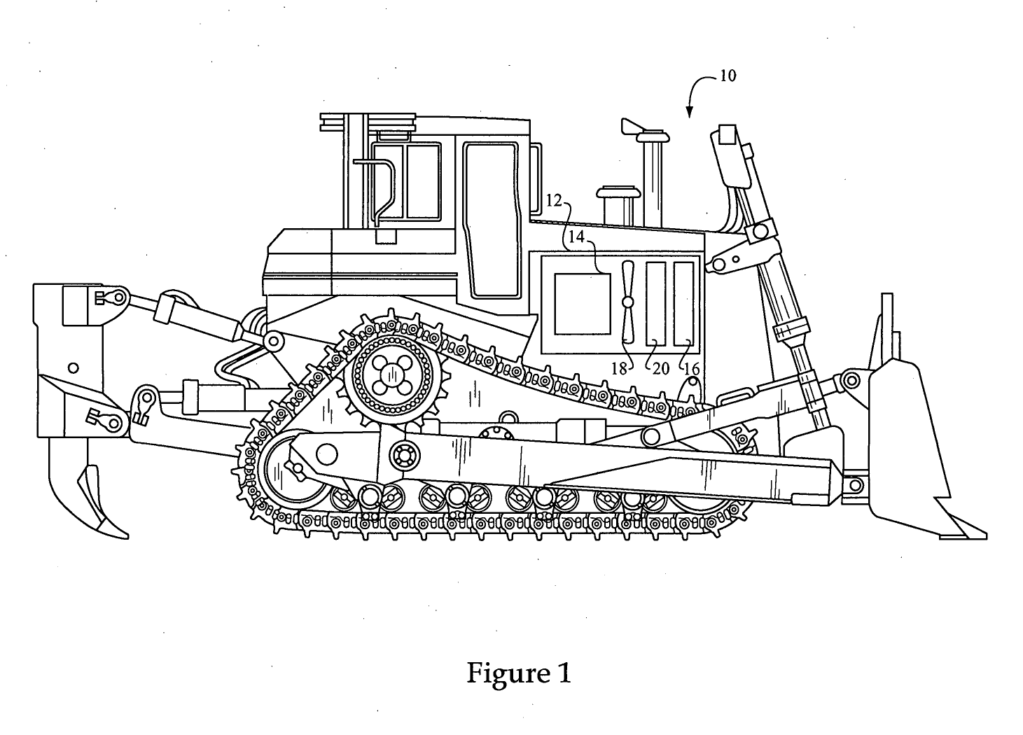

An exemplary embodiment of a machine 10 is shown generally in FIG. 1. The machine 10 may be an on-road vehicle or an off-road vehicle, such as, for example, a track-type tractor. In the illustrated embodiment, machine 10 generally comprises an internal combustion engine 12, such as, for example, a compression ignition engine. The engine 12 includes an engine block and head referred to generally as 14 and a heat exchanger, such as a radiator 16, fluidly connected to the engine block 14.

The engine 12 is cooled by a coolant that is circulated through the engine block 14 and the radiator 16. As the coolant circulates through the engine block 14, heat from the engine 12 is transferred to the coolant. Thereafter, as the heated coolant passes through the radiator 16, the heat from the coolant is transferred to ambient air that is drawn through the radiator by a fan 18. The engine 12 may include an additional heat exchanger, or more specifically, a charge air cooler, such as an air to air aftercooler 20, for cooling an intake air used for combustion in one or more cylinders. It will be appreciated by those skilled in the art that additional fans may be provided in the described configuration, such as a hydraulically or electrically actuated fan (not shown) located external to the radiator 16 for pushing ambient air over the radiator. It will also be appreciated by those skilled in the art that additional coolers may be implemented by the engine 12, such as, by way of example only, hydraulic oil coolers, transmission oil coolers, and fuel coolers.

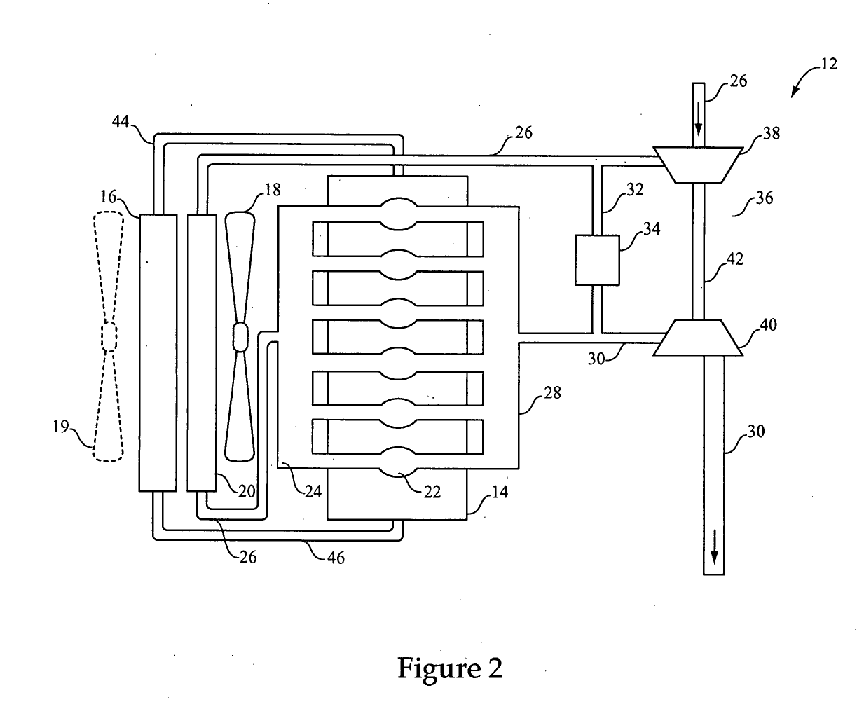

Referring to FIG. 2, there is shown a schematic view of internal combustion engine 12 incorporating a high pressure exhaust gas recirculation (EGR) system. For purposes of illustration, and not limitation, the engine 12 is that of a four-stroke, compression ignition engine and includes engine block 14 defining a plurality of combustion chambers or cylinders 22. In the exemplary engine 12, six combustion chambers 22 are shown, however, those skilled in the art will appreciate that any number of combustion chambers may be applicable.

The engine 12 includes an intake manifold 24 in communication with the combustion chambers 22 and capable of providing air to the engine via an intake air conduit 26. An exhaust manifold 28 is also in communication with the combustion chambers 22 and is capable of expending exhaust gas from the engine block via an exhaust conduit 30.

A recirculation conduit 32 provides a path for a portion of the exhaust expended through the exhaust conduit 30 to be rerouted to the intake manifold 24 via the intake conduit 26. One or more particulate filters, such as, for example, particulate filter 34, which may or may not include a catalyst coating, may be provided along the recirculation conduit 32 to trap particulate matter from the exhaust gas traveling through the conduit. One or more particulate filters may also be disposed along the exhaust conduit 30 for a similar purpose. Regenerating means may also be provided to periodically or continuously oxidize trapped particulate matter in the particulate filter 34.

The engine 12 also includes a turbocharger of standard design, shown generally at 36. Although one turbocharger is shown in the illustrated embodiment, it is known that more than one turbocharger in series or parallel may be used in engine 12. The turbocharger 36 includes a compressor 38 connected to a turbine 40 via a shaft 42. Exhaust gas leaving the exhaust manifold 28 passes through the exhaust conduit 30 and to a wheel of the turbine 40 to make it rotate. The rotation of the wheel turns the shaft 42 which, in turn, rotates a wheel of the compressor 38. The rotation of the compressor wheel pulls in ambient air through intake conduit 26 and compresses it.

The compressed air is combined with exhaust gas when the exhaust gas enters the intake conduit 26 from the recirculation conduit 32. Since both the exhaust gas and the compressed air are very hot, the intake conduit passes the combination through the air to air aftercooler 20 for cooling prior to introduction into the intake manifold 24. To comply with environmental regulations, especially NOₓ production, it is desirable to maintain the temperature of the air passing into the intake manifold below 70° Celsius.

The air to air aftercooler 20 is of standard design and is positioned for receiving ambient air moved through the radiator 16 by a radiator fan 18. As shown, the radiator fan 18 is configured to draw air sequentially through the radiator 16 and the air to air aftercooler 20. Alternatively, however, the radiator fan, shown in phantom at 19, may be positioned externally to the radiator 16 and may be configured to push ambient air sequentially through the radiator 16 and the air to air aftercooler 20. The air to air aftercooler 20 and radiator 16 may, for example, occupy approximately the same footprint or cross sectional area to the ambient air flow. Alternatively, the air to air aftercooler 20 may cover a larger or smaller surface area than that of the radiator 16. The air to air aftercooler 20 uses ambient air that is moved through the radiator 16 by fan 18, or alternatively fan 19, to cool the combination of compressed air and exhaust gas as it flows through the aftercooler. Prior to passing through the air to air aftercooler 20, the ambient air first passes through the radiator 16 where it cools a heated coolant fluid flowing from the engine block 14 via inlet passage 44. After the coolant fluid is cooled, it is returned to the engine block via outlet passage 46.

It will be appreciated by those skilled in the art that additional coolers may be implemented by the engine 12, such as, for example, hydraulic oil coolers, transmission oil coolers, and fuel coolers.

### INDUSTRIAL APPLICABILITY

Typical cooling systems of an engine incorporating a high pressure exhaust gas recirculation (EGR) system include a radiator for cooling the liquid engine coolant and an air to air aftercooler for cooling an intake mixture comprised of exhaust gas and compressed air prior to introduction into the engine.

In a typical configuration, the air to air aftercooler is mounted in series with the radiator, wherein ambient air is drawn in first through the air to air aftercooler and is thereafter drawn through the radiator. This configuration, in an engine incorporating a high pressure EGR, would have an adverse effect on the radiator. Specifically, the increased heat load on the air to air aftercooler, attributed to the high pressure EGR system, would cause ambient air passing through the air to air aftercooler to become heated. This heated ambient air, thereafter drawn through the radiator, may prevent the radiator from effectively cooling the engine.

As an alternative, the air to air aftercooler may be mounted in parallel to the radiator. While this configuration may minimize the issues of the previous configuration, the performance on each heat transfer device of the system normalized to the frontal area will be compromised. Heat exchangers are typically mounted to maximize a surface area for receiving a cooling air flow. Mounting the radiator and air to air aftercooler next to one another increases the overall frontal area of the cooling package. This is usually not preferred in any on-road or off-road vehicle. Increasing the depth of each heat transfer device to compensate for the decrease in the individual heat transfer frontal area will partially solve the problem.

In the configuration of the present disclosure, the air to air aftercooler is mounted in series with the radiator, so as each device may maximize the surface area of the wall in communication with the ambient air. However, in this series configuration, ambient air is moved first through the radiator and is thereafter moved through the air to air aftercooler. Referring to FIGS. 1 and 2, the cooling system of an engine 12 incorporating a high pressure EGR system includes a radiator for cooling an engine block 14 of the engine and an air to air aftercooler 20 for cooling a combination of exhaust gas and compressed air prior to introduction into an intake manifold 24 of the engine block. Specifically, a combination of compressed air and exhaust is cooled within the air to air aftercooler 20 using ambient air that has passed through the radiator 16. Although the ambient air passing through the radiator may be heated, the use of this heated air does not preclude the air to air aftercooler 20 from maintaining an inlet manifold temperature below 70° Celsius.

The advantage of the configuration of the present disclosure is the ability to upgrade an engine system in a fixed spatial envelope of a machine to include high pressure EGR for emissions reductions without costly redesign of the machine to increase the spatial envelope or by redesigning the radiator sizing and/or location and other aspects of engine cooling.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A machine, comprising:
an internal combustion engine having an intake manifold and an exhaust manifold;
an intake air conduit extending from a compressor of a turbocharger to the intake manifold, wherein a charge air cooler is disposed along the intake air conduit;
an exhaust conduit extending from the exhaust manifold to a turbine of the turbocharger;
a recirculation conduit, wherein an inlet of the recirculation conduit connects to the exhaust conduit and an outlet of the recirculation conduit connects to the intake air conduit upstream of the charge air cooler; and
a radiator fluidly connected to the internal combustion engine, wherein the charge air cooler is positioned for receiving ambient air moved through the radiator by a radiator fan.

2. The machine of claim 1, including a particulate filter disposed along the recirculation conduit.

3. The machine of claim 2, including means for regenerating the particulate filter.

4. The machine of claim 1, wherein the radiator fan is configured to draw in ambient air sequentially through the radiator and the charge air cooler.

5. The machine of claim 1, wherein the radiator fan is configured to push ambient air sequentially through the radiator and the charge air cooler.

6. The machine of claim 1, wherein the charge air cooler occupies approximately the same footprint as the radiator.

7. A method of operating an engine, comprising:
cooling an engine coolant within a radiator using ambient air moved through the radiator by a fan;
channeling exhaust into a recirculation conduit upstream of a turbine of a turbocharger;
combining the exhaust from the recirculation conduit with intake air, wherein the intake air includes air charged by a compressor of the turbocharger; and
cooling the combined exhaust and intake air with a charge air cooler using the ambient air that has passed through the radiator.

8. The method of claim 7, including:
trapping particulate matter from the exhaust air.

9. The method of claim 8, including:
oxidizing trapped particulate matter.

10. The method of claim 7, wherein the step of cooling the combined exhaust and intake air includes:
maintaining an inlet manifold temperature below 70 degrees Celsius.

11. The method of claim 7, including:
sizing the charge air cooler to occupy a footprint approximately the same as a footprint of the radiator.

12. The method of claim 7, including:
cooling the engine with the ambient air that has passed through the radiator and the charge air cooler.
